(19) United States
(12) Patent Application Publication
(10) Pub. No.: US 2024/0143870 A1
(43) Pub. Date: May 2, 2024

(54) INFORMATION PROCESSING APPARATUS AND INFORMATION PROCESSING METHOD

(71) Applicant: Tokyo Electron Limited, Tokyo (JP)

(72) Inventors: Hironori MOKI, Miyagi (JP); Tetsuya NISHIZUKA, Miyagi (JP); Masanobu HONDA, Miyagi (JP); Yusuke OGAWA, Hokkaido (JP)

(73) Assignee: Tokyo Electron Limited, Tokyo (JP)

(21) Appl. No.: 18/384,906

(22) Filed: Oct. 30, 2023

(30) Foreign Application Priority Data
Oct. 31, 2022 (JP) 2022-174106

(51) Int. Cl. G06F 30/20

(52) U.S. Cl. CPC G06F 30/20; G06F 2119/18

(57) ABSTRACT

An information processing apparatus includes a generation unit that generates simulation data including a plurality of combinations of unprocessed data of a workpiece and processed data of the workpiece after a process is performed on the workpiece under a predetermined process condition. Each of the plurality of combinations includes the unprocessed data and the processed data when the process is performed with a plurality of pattern densities for each of a plurality of mask shapes. The information processing apparatus further includes a derivation unit that derives simulation parameters of a shape simulator based on a closeness between predicted data that is predicted by inputting the unprocessed data included in the simulation data to the shape simulator, and the processed data combined with the unprocessed data.

### CROSS-REFERENCE TO RELATED APPLICATION

This application is based on and claims priority from Japanese Patent Application No. 2022-174106, filed on Oct. 31, 2022, with the Japan Patent Office, the disclosure of which is incorporated herein in its entirety by reference.

### TECHNICAL FIELD

The present disclosure relates to an information processing apparatus and an information processing method.

### BACKGROUND

In a process executing apparatus such as a semiconductor manufacturing apparatus, processes are executed on a workpiece under predetermined process conditions to perform a processing of a desired shape or a surface treatment. In order to optimize the process conditions for the processes executed by the process executing apparatus, it has been performed to predict data of a workpiece after the processes, using model data constructed to reproduce the change of the workpiece, which is the effect of the processes.

For example, International Patent Publication No. 2019/131608 discloses an information processing apparatus, which receives start state data of a workpiece and target end state data of the workpiece, predicts end state data of the workpiece using model data constructed to reproduce the change of the workpiece, which is the effect of a process, and determines process conditions for the process to be executed on the workpiece based on the closeness between the predicted end state data of the workpiece and the target end state data of the workpiece.

### SUMMARY

According to an aspect of the present disclosure, an information processing apparatus includes a generation unit that generates simulation data including a plurality of combinations of unprocessed data of a workpiece and processed data of the workpiece after a process is performed on the workpiece under a predetermined process condition. Each of the plurality of combinations includes the unprocessed data and the processed data when the process is performed with a plurality of pattern densities for each of a plurality of mask shapes. The information processing apparatus further includes a derivation unit that derives simulation parameters of a shape simulator based on a closeness between predicted data that is predicted by inputting the unprocessed data included in the simulation data to the shape simulator, and the processed data combined with the unprocessed data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an example of a substrate processing system.

FIG. 2 is a block diagram illustrating an example of a hardware configuration of a computer.

FIG. 3 is a conceptual view illustrating an example of collected data.

FIG. 4 is a block diagram illustrating an example of a functional configuration of a parameter derivation apparatus.

FIG. 5 is a block diagram illustrating a specific example of a process performed by a generation unit.

FIG. 6 is a conceptual view illustrating a specific example of simulation data.

FIG. 7 is a conceptual view illustrating a specific example of simulation data.

FIG. 8 is a conceptual view illustrating a specific example of simulation data.

FIG. 9 is a block diagram illustrating a specific example of a process performed by an integration unit.

FIG. 10 is a view illustrating a specific example of recipe parameters.

FIG. 11 is a view illustrating a specific example of simulation parameters.

FIG. 12 is a block diagram illustrating a specific example of a process performed by a calculated unit.

FIG. 13 is a block diagram illustrating a specific example of a process performed by a derivation unit.

FIG. 14 is a flowchart illustrating an example of a parameter deriving method.

FIG. 15 is a block diagram illustrating an example of a functional configuration of a process condition optimization apparatus.

FIG. 16 is a view illustrating a specific example of model data.

FIG. 17 is a conceptual view illustrating a specific example of modulated image data.

FIG. 18 is a conceptual view illustrating a specific example of modulated image data.

FIG. 19 is a flowchart illustrating an example of a process condition optimization method.

FIG. 20 is a conceptual diagram illustrating an example of a process of reading out a combination of multiple model data.

FIG. 21 is a conceptual diagram illustrating an example of a process of reading out a combination of multiple model data.

FIG. 22 is a conceptual diagram illustrating an example of a process of reading out a combination of multiple model data.

FIG. 23 is a conceptual view illustrating an example of a prediction process.

FIG. 24 is a conceptual view illustrating an example of a process performed by a process condition optimization apparatus.

FIG. 25 is a conceptual view illustrating an example of a process performed by a process condition optimization apparatus.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made without departing from the spirit or scope of the subject matter presented here.

Hereinafter, embodiments for implementing the present disclosure will be described with reference to the drawings. In the respective drawings, the same components may be denoted by the same reference numerals, and overlapping descriptions thereof may be omitted.

### EMBODIMENTS

### System Configuration

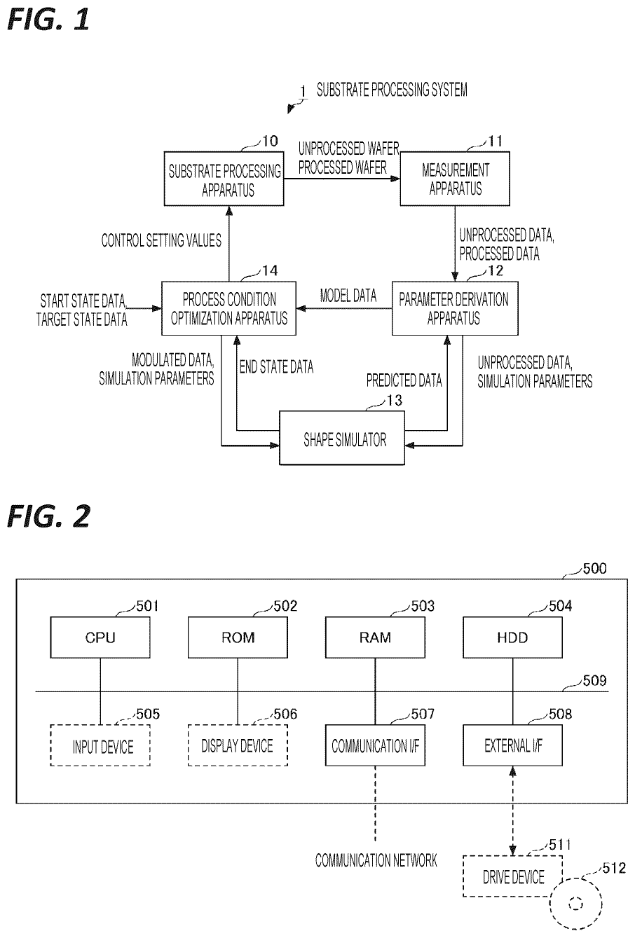

An example of a system configuration of a substrate processing system according to an embodiment of the present disclosure will be described with reference to FIG. 1. FIG. 1 is a block diagram illustrating an example of the system configuration of the substrate processing system according to the embodiment.

As illustrated in FIG. 1, a substrate processing system 1 according to the present embodiment includes a substrate processing apparatus 10, a measurement apparatus 11, a parameter derivation apparatus 12, a shape simulator 13, and a process condition optimization apparatus 14. The substrate processing apparatus 10, the measurement apparatus 11, the parameter derivation apparatus 12, the shape simulator 13, and the process condition optimization apparatus 14 are connected to each other via a communication network such as a local area network (LAN) or the Internet to communicate data with each other.

The substrate processing apparatus 10 executes various substrate manufacturing processes (e.g., dry etching and deposition) when a plurality of unprocessed wafers (workpieces) is transferred therein. A portion of the plurality of unprocessed wafers is transferred to the measurement apparatus 11.

After the various substrate manufacturing processes are executed by the substrate processing apparatus 10, the processed wafers are carried out from the substrate processing apparatus 10. At this time, the substrate processing apparatus 10 retains process conditions (e.g., process data acquired during the execution of the various substrate manufacturing processes, and recipe parameters used during the executing of the various substrate manufacturing processes). A portion of the plurality of processed wafers is transferred to the measurement apparatus 11.

When an unprocessed wafer is transferred from the substrate processing apparatus 10, the measurement apparatus 11 measures the shape of the unprocessed wafer. The measurement apparatus 11 measures the cross-sectional shape of the unprocessed wafer by cutting the unprocessed wafer in the cross-sectional direction at various locations. As a result, the measurement apparatus 11 generates an unprocessed cross-section image that represents the shape of the cross-section of the unprocessed wafer. The measurement apparatus 11 may measure the shape of the upper surface of the unprocessed wafer. As a result, the measurement apparatus 11 generates an unprocessed upper surface image that represents the shape of the upper surface of the unprocessed wafer.

After measuring the shape of the unprocessed wafer, the measurement apparatus 11 generates unprocessed image data (hereinafter, also simply referred to as “unprocessed data”) obtained by measuring the shape of the unprocessed wafer. The unprocessed image data includes the unprocessed cross-section image. When the measurement apparatus 11 measures the shape of the upper surface of the unprocessed wafer, the unprocessed image data includes the unprocessed upper surface image.

When a processed wafer is transferred from the substrate processing apparatus 10, the measurement apparatus 11 measures the shape of the processed wafer, and generates processed image data that represents the shape of the processed wafer (hereinafter, also simply referred to as “processed data”). The processed image data includes a processed cross-section image that represents the shape of the cross section of the processed wafer. The processed image data may include a processed upper surface image that represents the shape of the upper surface of the processed wafer.

The measurement apparatus 11 includes, for example, a scanning electron microscope (SEM), a transmission electron microscope (TEM), an atomic force microscope (AFM), and a focused ion beam scanning electron microscope (FIB SEM).

For example, the unprocessed image data and the processed image data generated by the measurement apparatus 11, and the process data and the recipe parameters retained by the substrate processing apparatus 10 are transmitted as collected data to the parameter derivation apparatus 12. The collected data are stored in a storage unit of the parameter derivation apparatus 12.

The parameter derivation apparatus 12 reads out the collected data stored in the storage unit, and generates simulation data to be input to the shape simulator 13. The parameter derivation apparatus 12 stores the generated simulation data in the storage unit.

The simulation data is an example of a combination of data showing the unprocessed shape of a substrate and data showing the processed shape of a substrate, and include a plurality of combinations of the unprocessed image data and the processed image data included in the collected data. The simulation data is classified and managed by group of process conditions (e.g., process data, recipe parameters, or physical quantities (using, for example, virtual sensors and metrology) calculated from observation values), which produce the same effect in the change of the shape between the unprocessed workpiece and the processed workpiece.

In the present embodiment, “Proxel” refers to a group of process conditions that produce the same effect in the change of the shape between the unprocessed workpiece and the processed workpiece. The “Proxel” is the smallest data unit (process element) for a process executed on a workpiece, and is a similar name to “pixel,” which is the smallest unit of an image (picture element), or “voxel,” which is the smallest unit of a volume (volume element). Here, it is assumed that the “same effect” indicates a substantially similar change (within a predetermined range) in the shape of the workpiece, rather than exactly the same change in the shape of the workpiece.

The parameter derivation apparatus 12 reads out the plurality of combinations of unprocessed image data and processed image data that are included in the simulation data of a specific Proxel among the simulation data classified by Proxel. When the parameter derivation apparatus 12 inputs a plurality of unprocessed image data included in the read-out plurality of combinations to the shape simulator 13, the shape simulator 13 acquires a plurality of predicted image data (hereinafter, also simply referred to as “predicted data”).

When the unprocessed image data includes an unprocessed cross-sectional shape, the predicted image data includes a predicted cross-section image that predicts the cross-sectional shape of the processed workpiece. When the unprocessed image data includes an unprocessed upper surface shape, the predicted image data includes a predicted upper surface image that predicts the upper surface shape of the processed workpiece. When the unprocessed image data includes three-dimensional structure information generated from the unprocessed cross-sectional shape and the unprocessed upper surface shape, the predicted image data includes three-dimensional structure information that predicts the three-dimensional structure information of the processed workpiece.

When operating the shape simulator 13, the parameter derivation apparatus 12 repeatedly inputs the plurality of unprocessed image data to the shape simulator 13 while altering simulation parameter values. At this time, the parameter derivation apparatus 12 alters the simulation parameter values such that the plurality of predicted image data repeatedly output from the shape simulator 13 become similar to the associated plurality of processed image data.

As a result, the parameter derivation apparatus 12 may derive optimal simulation parameter values, at which the plurality of predicted image data are closest to the associated plurality of processed image data. That is, the parameter derivation apparatus 12 may derive a global optimal solution.

The shape simulator 13 operates when the unprocessed image data and the simulation parameter values are input from the parameter derivation apparatus 12, and as a result, outputs the predicted image data.

The process condition optimization apparatus 14 determines model data or a combination of multiple model data that may produce an output close to target state data indicating the target end state of the workpiece, by using model data constructed to reproduce the change of the workpiece as the effect of the various processes. The model data may be stored in advance in the process condition optimization apparatus 14, or may be stored in another apparatus, from which the process condition optimization apparatus 14 may read the model data through a communication network.

The process condition optimization apparatus 14 selects, as an optimal solution, model data or a combination of multiple model data that changes the input start state data to the end state data with the highest closeness to the target state data. The process condition optimization apparatus 14 may select model data or a combination of multiple model data as an optimal solution, based on a plurality of target values including process time, environmental load indicators, or a combination thereof The process condition optimization apparatus 14 determines setting data (recipe parameters) included in the model data selected as the optimal solution, to be setting values (control setting values) for the control components of the substrate processing apparatus 10.

The process condition optimization apparatus 14 may output the determined control setting values to the substrate processing apparatus 10, to control the processes performed by the substrate processing apparatus 10. In this case, the substrate processing apparatus 10 performs the processes based on the control setting values input from the process condition optimization apparatus 14.

The process condition optimization apparatus 14 may display the determined control setting values on a display device. Further, the process condition optimization apparatus 14 may display the determined control setting values on a display device of a user terminal used by a user of the substrate processing apparatus 10. In this case, the user of the substrate processing apparatus 10 sets the control setting values displayed on the display device, in the substrate processing apparatus 10. The substrate processing apparatus 10 performs the processes based on the control setting values set by the user.

The system configuration of the substrate processing system 1 illustrated in FIG. 1 is an example, and various examples of the system configuration may be conceived according to the utilization or application of the substrate processing system 1. While FIG. 1 illustrates the substrate processing system 10, the measurement apparatus 11, the parameter derivation apparatus 12, the shape simulator 13, and the process condition optimization apparatus 14, this distribution of apparatuses is an example. For example, various configurations may be conceived, such as a configuration in which at least two of the parameter derivation apparatus 12, the shape simulator 13, and the process condition optimization apparatus 14 are integrated, or a configuration in which the parameter derivation apparatus 12, the shape simulator 13, or the process condition optimization apparatus 14 is separated.

### Hardware Configuration

The hardware configuration of the substrate processing system 1 according to the present embodiment will be described with reference to FIG. 2. The parameter derivation apparatus 12, the shape simulator 13, and the process condition optimization apparatus 14 in the present embodiment are implemented by, for example, a computer. FIG. 2 is a block diagram illustrating an example of the hardware configuration of the computer according to the present embodiment.

As illustrated in FIG. 2, a computer 500 includes a central processing unit (CPU) 501, a read only memory (ROM) 502, a random access memory (RAM) 503, a hard disk drive (HDD) 504, an input device 505, a display device 506, a communication interface (I/F) 507, and an external IN 508. The CPU 501, the ROM 502, and the RAM 503 form a so-called computer. The hardware components of the computer 500 are connected to each other via a bus line 509. The input device 505 and the display device 506 may be used by being connected to the external I/F 508.

The CPU 501 is an arithmetic device that implements the overall control or functions of the computer 500 by reading programs or data from a storage device such as the ROM 502 or the HDD 504 onto the RAM 503 and executing processes.

The ROM 502 is an example of a nonvolatile semiconductor memory (storage device) capable of storing programs or data even when the power is turned off. The ROM 502 functions as a main storage device that stores, for example, various programs and data necessary when the CPU 501 executes various programs installed in the HDD 504. Specifically, the ROM 502 stores boot programs such as the basic input/output system (BIOS) and the extensible firmware interface (EFI) that are executed when the computer 500 is started, or data such as operation system (OS) settings and network settings.

The RAM 503 is an example of a volatile semiconductor memory (storage device), in which programs or data are erased when the power is turned off. The RAM 503 is, for example, a dynamic random access memory (DRAM) or a static random access memory (SRAM). The RAM 503 provides a work area, in which the various programs installed in the HDD 504 are deployed when the programs are executed by the CPU 501.

The HDD 504 is an example of a nonvolatile storage device that stores programs or data. The programs or data stored in the HDD 504 include, for example, the operating system (OS) that is the basic software for controlling the entire computer 500, and applications that provide various functions on the OS. The computer 500 may use a storage device that employs a flash memory as a storage medium (e.g., the solid state drive (SSD)), instead of the HDD 504.

The input device 505 is, for example, a touch panel, operation keys or buttons, or a keyboard or a mouse, which are used by the user to input various signals, or a microphone for inputting sound data such as voice.

The display device 506 is configured with, for example, a display such as a liquid crystal or organic electro-luminescence (EL), and a speaker that outputs sound data such as voice.

The communication I/F 507 is an interface connected to a communication network, allowing the computer 500 to perform a data communication.

The external I/F 508 is an interface with an external device. The external device is, for example, a drive device 511.

The drive device 511 is a device for setting a record medium 512. The record medium 512 herein includes a medium that records information optically, electrically, or magnetically, such as a CD-ROM, a flexible disk, or a magneto-optical disk. The record medium 512 may also include, for example, a semiconductor memory that electrically records information, such as a ROM or a flash memory. Thus, the computer 500 may perform a reading and/or a recording with respect to the recording medium 512 via the external I/F 508.

Various programs are installed in the HDD 504, for example, in the manner that the distributed record medium 512 is set in the drive device 511 connected to the external I/F 508, and the various programs recorded on the record medium 512 are read out by the drive device 511. Alternatively, the various programs may be installed in the HDD 504 in the manner that the various programs are downloaded from another network different from the communication network via the communication I/F 507.

### Specific Example of Collected Data

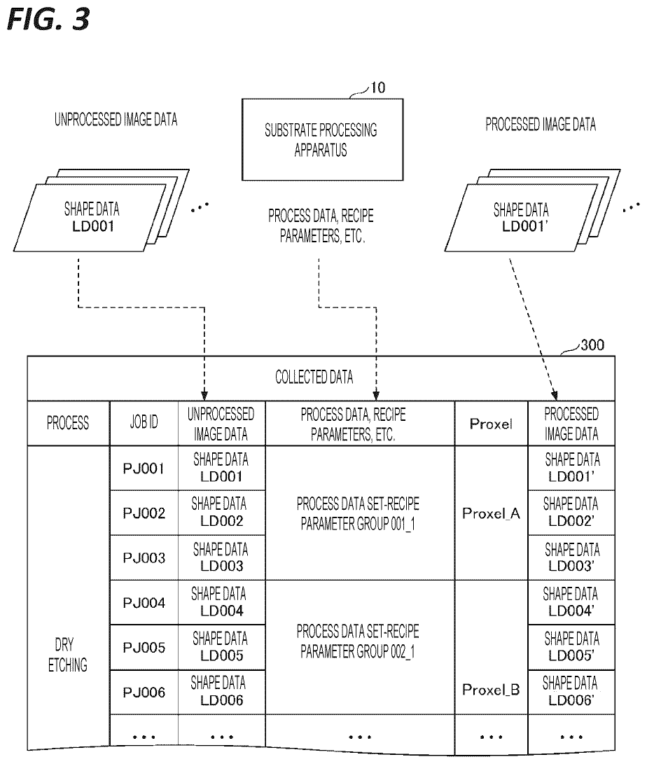

A specific example of the collected data stored by the parameter derivation apparatus 12 will be described. FIG. 3 is a view illustrating an example of the collected data according to the present embodiment.

As illustrated in FIG. 3, collected data 300 include information items of “Process,” “Job ID,” “Unprocessed Image Data,” “Process Data, Recipe Parameters, etc.,” “Proxel,” and “Processed Image Data.”

The “Process” stores a name of a substrate manufacturing process. The example of FIG. 3 represents a state where a “dry etching” is stored as the “Process.”

The “Job ID” stores an identifier that identifies a job, which is executed by the substrate processing apparatus 10. The example of FIG. 3 represents a state where “PJ001,” “PJ002,” and “PJ003” are each stored as the “Job ID” of the dry etching.

The “Unprocessed Image Data” stores a file name of unprocessed image data generated by the measurement apparatus 11. For Job ID=“PJ001,” the example of FIG. 3 represents that unprocessed image data with the file name=“Shape Data LD001” is generated by the measurement apparatus 11 for one unprocessed wafer of a lot (wafer group) to be subjected to the corresponding job.

For Job ID=“PJ002,” the example of FIG. 3 represents that unprocessed image data with the file name=“Shape Data LD002” is generated by the measurement apparatus 11 for one unprocessed wafer of a lot (wafer group) to be subjected to the corresponding job. For Job ID=“PJ003,” the example of FIG. 3 represents that unprocessed image data with the file name=“Shape Data LD003” is generated by the measurement apparatus 11 for one unprocessed wafer of a lot (wafer group) to be subjected to the corresponding job.

The “Process Data, Recipe Parameters, etc.” stores process conditions (e.g., process data and recipe parameters) that are retained when a wafer processed in the substrate processing apparatus 10 is transferred. In the example of FIG. 3, the “Process Data Set-Recipe Parameter Group 001_1” stores, for example, the following process data:

data output from the substrate processing apparatus 10 during processes, such as Vpp (potential difference), Vdc (direct current (DC) self-bias voltage), OES (emission intensity by optical emission spectrometry), Reflect (reflected wave power), and Top DCS current (detected value of Doppler current sensor); and
data measured during processes, such as plasma density, ion energy, and ion flux.

The “Process Data Set-Recipe Parameter Group 001_1” may also include values calculated from the data output from the substrate processing apparatus 10 and the data measured during processes.

In the example of FIG. 3, the “Process Data Set-Recipe Parameter Group 001_1” further stores, for example, the following data:
data set as setting values in the substrate processing apparatus 10, such as Pressure (pressure in a chamber), Power (power of a radio-frequency power supply), Gas (gas flow rate), and Temperature (temperature in the chamber or temperature of the wafer surface); and
data set as target values in the substrate processing apparatus 10, such as CD (critical dimension), Depth (depth), Taper (tapering angle), Tilting (tilt angle), and Bowing (bowing).

The “Proxel” stores a name of Proxel indicating a group into which the process data (included in the process data set), the recipe parameters (included in the recipe parameter set) and others stored in the “Process Data, Recipe Parameters, etc.” are classified. The example of FIG. 3 represents that the process data and the recipe parameters, etc., corresponding to Job IDs=“PJ001” to “PJ003” are classified into “Proxel_A,” and the process data and the recipe parameters, etc., corresponding to Job IDs=“PJ004” to “PJ006” are classified into “Proxel_B.”

The Proxel is a group classified based on the process data and the recipe parameters, etc. Thus, as illustrated in FIG. 3, even different jobs may be classified into the same Proxel when the jobs have the same process data and recipe parameters, etc.

The “Processed Image Data” stores a file name of processed image data generated by the measurement apparatus 11. For Job ID=“PJ001,” the example of FIG. 3 represents that processed image data with the file name=“Shape Data LD001” is generated by the measurement apparatus 11 for one processed wafer of a lot (wafer group) subjected to the corresponding job.

For Job ID=“PJ002,” the example of FIG. 3 represents that processed image data with the file name=“Shape Data LD002” is generated by the measurement apparatus 11 for one processed wafer of a lot (wafer group) subjected to the corresponding job. For Job ID=“PJ003,” the example of FIG. 3 represents that processed image data with the file name=“Shape Data LD003” is generated by the measurement apparatus 11 for one processed wafer of a lot (wafer group) subjected to the corresponding job.

### Functional Configuration of Parameter Derivation Apparatus

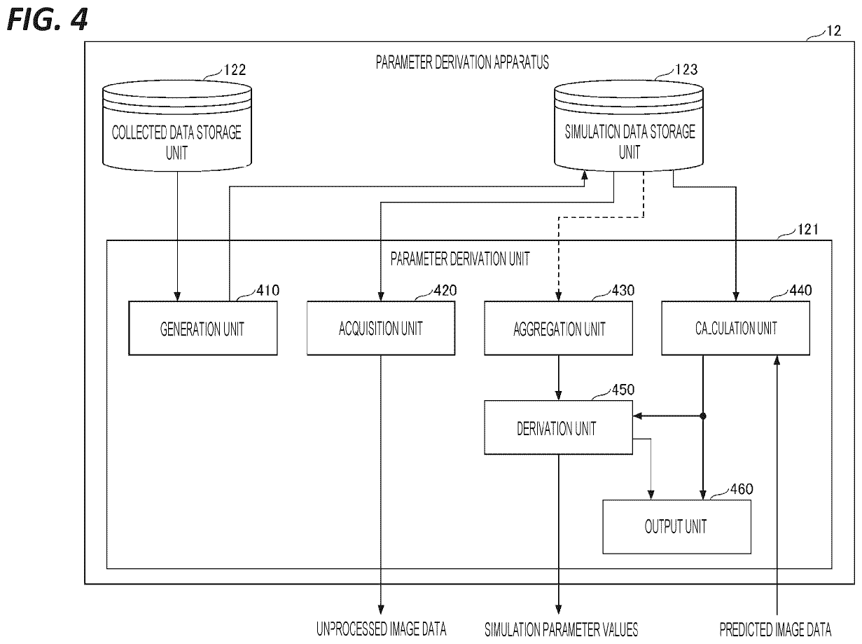

FIG. 4 is a block diagram illustrating an example of a functional configuration of the parameter derivation apparatus 12 according to the present embodiment. As illustrated in FIG. 4, the parameter derivation apparatus 12 of the present embodiment includes a parameter derivation unit 121, a collected data storage unit 122, and a simulation data storage unit 123. The parameter derivation unit 121 includes a generation unit 410, an acquisition unit 420, an aggregation unit 430, a calculation unit 440, a derivation unit 450, and an output unit 460.

The parameter derivation unit 121 is implemented in the manner that, for example, the CPU 501 illustrated in FIG. 2 executes programs loaded on the RAM 503. The collected data storage unit 122 and the simulation data storage unit 123 are implemented by, for example, the RAM 503 or the HDD 504 illustrated in FIG. 2.

The generation unit 410 reads out the collected data stored in the collected data storage unit 122, and generates the simulation data. The generation unit 410 stores the generated simulation data in the simulation data storage unit 123. The generation unit 410 generates the simulation data per same Proxel.

The acquisition unit 420 reads out, from the simulation data storage unit 123, a plurality of unprocessed image data among a plurality of combinations of unprocessed image data and processed image data included in the simulation data of a specific Proxel. The acquisition unit 420 inputs the read-out plurality of unprocessed image data to the shape simulator 13, thereby operating the shape simulator 13.

In the case of operating the shape simulator 13 using the simulation data of the specific Proxel, the aggregation unit 430 generates simulation parameter items to be input to the shape simulator 13. The aggregation unit 430 generates the simulation parameter items by referring to the items of the process data and the items of the recipe parameters, etc., included in the Proxel.

The calculation unit 440 acquires a plurality of predicted image data output from the shape simulator 13 as a result of the input of the plurality of unprocessed image data by the acquisition unit 420. The calculation unit 440 reads out the plurality of processed image data corresponding to the plurality of unprocessed image data from the simulation data storage unit 123, and calculates the closeness between each of the read-out plurality of processed image data and each of the acquired plurality of predicted image data. The calculation unit 440 notifies each calculated closeness (closenesses corresponding to the number of processed image data and predicted image data) to the derivation unit 450.

In the present embodiment, for example, the Intersection over Union (IoU) evaluation indicator may be used to evaluate the closeness. The IoU evaluation indicator indicates the extent of overlap between two regions. The IoU evaluation indicator is a value obtained by dividing an overlapping part of two regions by the union of the regions. The IoU evaluation indicator takes a value of 0 or more and 1 or less, and it is evaluated that the closer the value is to 1, the closer the two regions are.

In the present embodiment, the closeness is not limited to the IoU evaluation indicator. Any other evaluation indicators may be used as long as the similarity of images may be evaluated, such as a deviation between feature amounts extracted from images. Not only the closeness, but also a process time, an environmental load indicator, or a combination thereof may be used as an evaluation indicator.

The derivation unit 450 calculates the simulation parameter values to be input to the shape simulator 13. At first, the derivation unit 450 sets a predetermined initial value for each simulation parameter item generated by the aggregation unit 430, and inputs the value to the shape simulator 13.

Next, the derivation unit 450 acquires the closeness from the calculation unit 440. The derivation unit 450 alters the simulation parameter values such that each acquired closeness increases. The derivation unit 450 inputs the altered simulation parameter values to the shape simulator 13. The derivation unit 450 repeats this process until each closeness becomes equal to or more than a predetermined threshold value (e.g., 0.99).

The output unit 460 acquires, from the derivation unit 450, the simulation parameter values, at which each closeness calculated by the calculation unit 440 becomes equal to or more than the predetermined threshold value. The output unit 460 outputs the simulation parameter values acquired from the derivation unit 450 as optimal simulation parameter values.

### Specific Example of Process Performed by Each Unit of Parameter Derivation Apparatus

Descriptions will be made on a specific example of a process performed by each unit of the parameter derivation apparatus 12 (the generation unit 410, the aggregation unit 430, the calculation unit 440, and the derivation unit 450 in the present embodiment).

### (1) Specific Example of Process Performed by Generation Unit

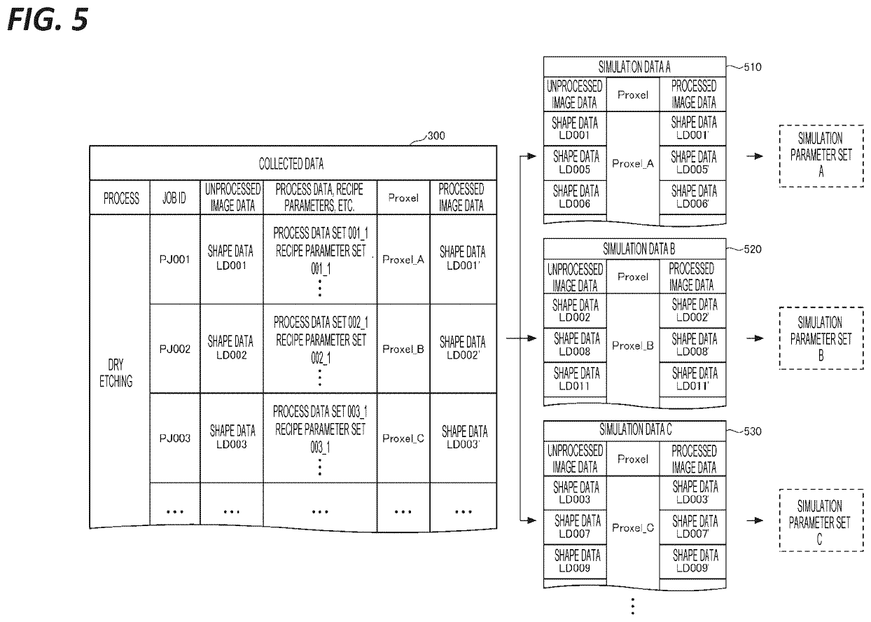

A specific example of the process performed by the generation unit 410 will be described first. FIG. 5 is a view illustrating a specific example of the process performed by the generation unit.

As illustrated in FIG. 5, the generation unit 410 reads out the collected data 300 from the collected data storage unit 122, and generates the simulation data per same Proxel.

The example of FIG. 5 represents a state where the generation unit 410 generates the following simulation data based on the collected data 300:
simulation data 510 (data name=“Simulation Data A”);
simulation data 520 (data name=“Simulation Data B”); and
simulation data 530 (data name=“Simulation Data C”).

In the example of FIG. 5, the simulation data 510 consists of combinations associated with Proxel name=“Proxel A” among the plurality of combinations included in the collected data 300.

Similarly, in the example of FIG. 5, the simulation data 520 consists of combinations associated with Proxel name=“Proxel_B” among the plurality of combinations included in the collected data 300.

Similarly, in the example of FIG. 5, the simulation data 530 consists of combinations associated with Proxel name=“Proxel_C” among the plurality of combinations included in the collected data 300.

Meanwhile, as described above, the parameter derivation unit 121 derives the optimal simulation parameter values using the simulation data per same Proxel. The example of FIG. 5 represents the following state:
the optimal simulation parameter values are derived using the simulation data 510, and a simulation parameter set A is output;
the optimal simulation parameter values are derived using the simulation data 520, and a simulation parameter set B is output; and
the optimal simulation parameter values are derived using the simulation data 530, and a simulation parameter set C is output.

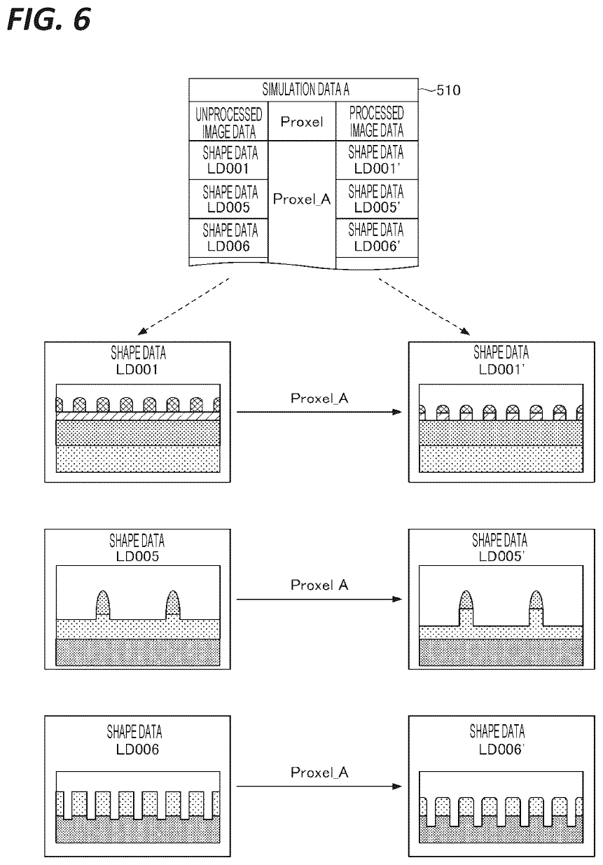

Next, a specific example of the simulation data will be described. FIG. 6 is a view illustrating a specific example of the simulation data stored in the simulation data storage unit 123.

In FIG. 6, the unprocessed image data on the left side of the paper are unprocessed image data with the file names of “Shape Data LD001,” “Shape Data LD005,” and “Shape Data LD006,” respectively. In FIG. 6, the processed image data on the right side of the paper are processed image data with the file names “Shape Data LD001′,” “Shape Data LD005′,” and “Shape Data LD006′,” respectively.

As described above, the common simulation parameter set A consisting of the optimal simulation parameter values is output for the plurality of combinations of unprocessed image data and processed image data included in the simulation data 510. The generation unit 410 generates the simulation data 510 using image data with different shapes, so that the simulation parameter set A to be output becomes a more global optimal solution.

Specifically, the simulation data 510 may be configured such that unprocessed image data included in any one combination has a different shape from unprocessed image data included in any of the other combinations (see the left side of the paper of FIG. 6). Further, the simulation data 510 may be configured such that processed image data included in any one combination has a different shape from processed image data included in any of the other combinations (see the right side of the paper of FIG. 6). That is, the simulation data for the same Proxel is configured with combinations in which an unprocessed or processed shape in any one combination is different from unprocessed and processed shapes in the other combinations.

In this way, the parameter derivation unit 121 derives the optimal simulation parameters by using the plurality of combinations with different shapes from each other, rather than simply using a plurality of combinations. As a result, the parameter derivation unit 121 may derive a more global optimal solution.

FIG. 6 illustrates an example where both the unprocessed image data and the processed image data have different shapes from each other. However, either one side of the unprocessed image data and the processed image data may have different shapes from each other.

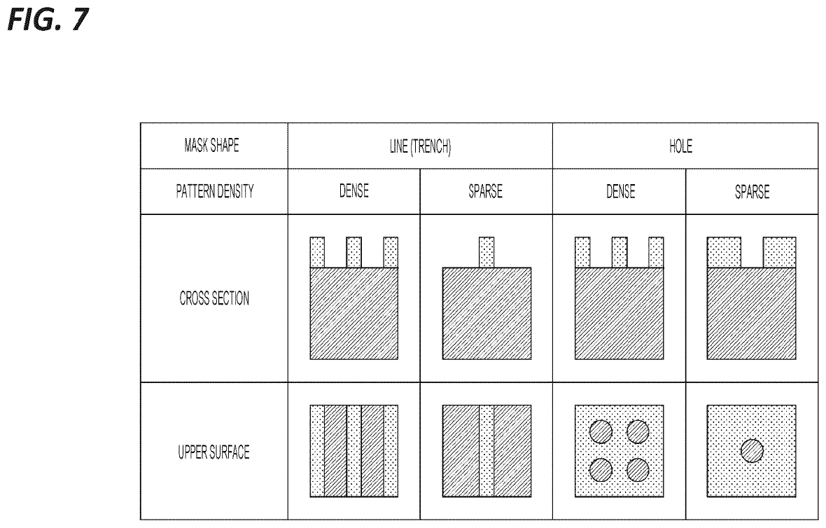

In the present embodiment, the simulation data includes processed image data, in which a process is performed with a plurality of pattern densities for each of a plurality of mask shapes. FIG. 7 illustrates an example of the simulation data generated with a plurality of pattern densities for each of a plurality of mask shapes. As illustrated in FIG. 7, the plurality of mask shapes include, for example, a line (trench) shape and a hole shape. The plurality of pattern densities represent the size (sparse or dense) of the spacing between lines (trenches) or holes formed by the process. The patterns may include, for example, a lattice arrangement or a hexagonal close arrangement.

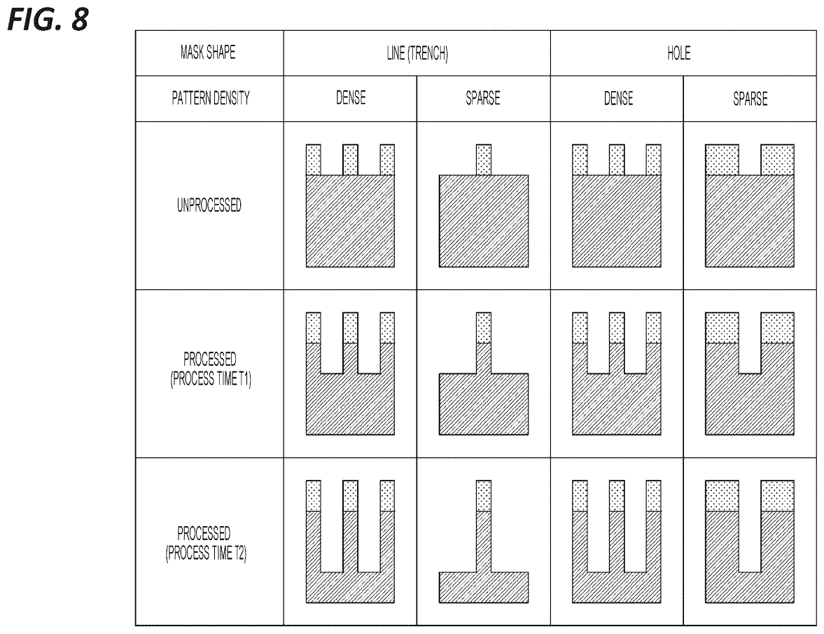

In the present embodiment, the simulation data includes processed image data with different process times for each process. FIG. 8 is a view illustrating an example of the simulation data generated according to a plurality of process times. As illustrated in FIG. 8, the plurality of process times include a predetermined process time T1 and a process time T2 longer than T1.

The simulation data may include processed image data, in which a process is performed according to the plurality of process times, in a portion of the combinations of the plurality of mask shapes and the plurality of pattern densities. The simulation data may include processed image data, in which a process is performed according to the plurality of process times, in all of the combinations of the plurality of mask shapes and the plurality of pattern densities.

As for the plurality of process times, the interval of process time may be shortened near the boundary between layers with different film types on the workpiece. For example, in a case where processed image data is generated at the interval of ΔT1 for an L-th layer, processed image data when the process shifts from the L-th layer to an L+1-th layer may be generated at the interval of ΔT2 shorter than ΔT1 For example, in the dry etching process, the process speed per unit time is constant on layers with the same film type, but differs between different film types. Thus, when processed image data is generated at the shorter time interval near the boundary where the film type switches, it is expected to obtain the simulation parameters that may reproduce the change of the workpiece with the higher precision.

### (2) Specific Example of Process Performed by Aggregation Unit

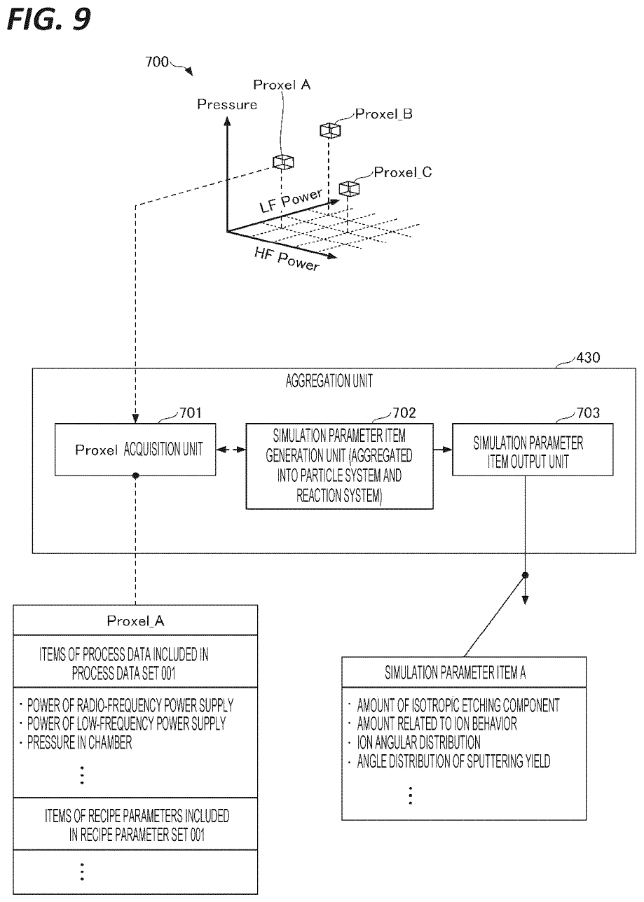

Next, a specific example of the process performed by the aggregation unit 430 will be described. FIG. 9 is a view illustrating a specific example of the process performed by the aggregation unit.

As illustrated in FIG. 9, the aggregation unit 430 includes a Proxel acquisition unit 701, a simulation parameter item generation unit 702, and a simulation parameter item output unit 703.

The Proxel acquisition unit 701 acquires the items of the process data and the items of the recipe parameters that form a Proxel corresponding to particular simulation data among the simulation data stored in the simulation data storage unit 123.

Proxel_A to Proxel_C, each of which is an example of Proxel, are generated by defining subspaces with plots that have the same effect, in a multi-dimensional space 700 formed by the items of the process data and the items of the recipe parameters, etc. FIG. 9 illustrates the subspace of each Proxel generated in a three-dimensional space formed by the power of a radio-frequency power supply, the power of a low-frequency power supply, and the pressure in a chamber.

In order to derive the optimal simulation parameter values using the simulation data of Proxel_A, the Proxel acquisition unit 701 acquires, for example, the following data that form Proxel_A:
items and values of the process data (included in Process Data Set 001); and
items and values of the recipe parameters (included in Recipe Parameter Set 001).

The example of FIG. 9 represents a state where the Proxel acquisition unit 701 acquires the power of the radio-frequency power supply, the power of the low-frequency power supply, and the pressure in the chamber.

The simulation parameter item generation unit 702 refers to the items and values of the process data and the items and values of the recipe parameters acquired by the Proxel acquisition unit 701, and generates simulation parameter items A for the shape simulator 13. For example, the simulation parameter item generation unit 702 generates the items A aggregated into particle-system simulation parameters and reaction-system simulation parameters. Further, the simulation parameter item generation unit 702 may generate the simulation parameter items, by reflecting a domain knowledge.

In the example of FIG. 9, for example, an amount of an isotropic etching component is generated as an item of the particle-system simulation parameters. As items of the reaction-system simulation parameters, for example, an amount related to an ion behavior, an ion angular distribution, and an angle distribution of sputtering yield are generated.

In this way, the simulation parameter item generation unit 702 abstracts the items of the process data and the items of the recipe parameters, etc., that form the Proxel, into categories of reaction elements that do not overlap as physical phenomena, thereby generating the simulation parameter items A. As a result, the simulation parameter item generation unit 702 may generate the simulation parameter items A with the reduced number of dimensions.

The simulation parameter item output unit 703 outputs the simulation parameter items A generated by the simulation parameter item generation unit 702 to the derivation unit 450.

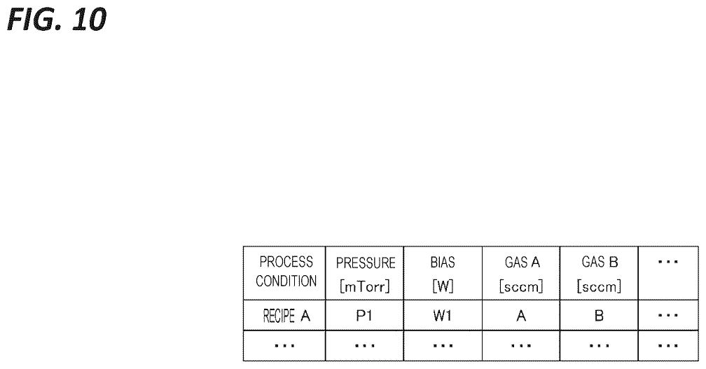

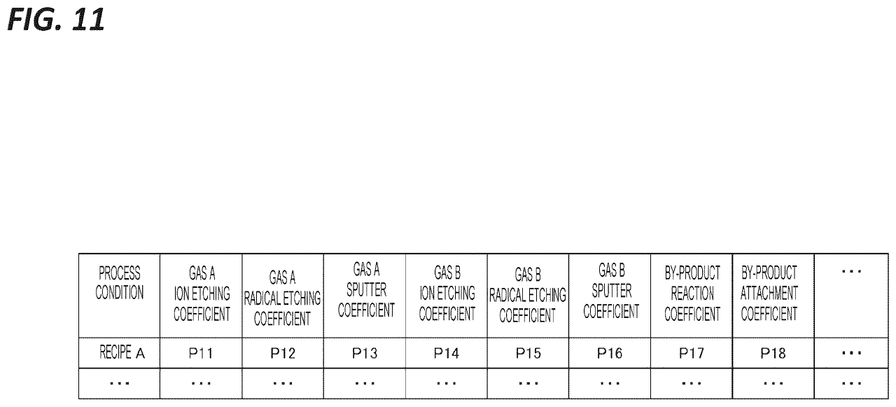

FIG. 10 is a view illustrating a specific example of the recipe parameters for the dry etching process. FIG. 11 is a view illustrating a specific example of the simulation parameters of the shape simulator 13 generated based on the recipe parameters illustrated in FIG. 10. The initial values P11 to P18 set for the simulation parameters may be, for example, values actually measured by sensors during the process, values publicly available in literatures, etc., optimal values obtained in similar processes, or random values.

### (3) Specific Example of Process Performed by Calculation Unit

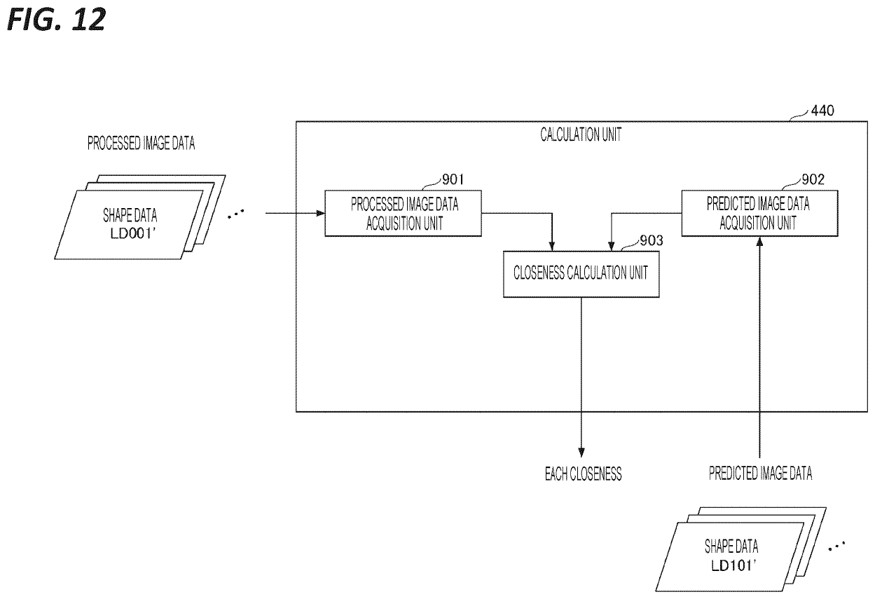

Next, a specific example of a process performed by the calculation unit 440 will be described. FIG. 12 is a view illustrating a specific example of the process performed by the calculation unit.

As illustrated in FIG. 12, the calculation unit 440 includes a processed image data acquisition unit 901, a predicted image data acquisition unit 902, and a closeness calculation unit 903.

The processed image data acquisition unit 901 acquires the processed image data (e.g., shape data LD001′, LD005′, and LD006′) corresponding to the plurality of unprocessed image data (e.g., the shape data LD001, LD005, and LD006) input to the shape simulator 13. The processed image data acquisition unit 901 notifies the acquired processed image data to the closeness calculation unit 903.

The predicted image data acquisition unit 902 acquires a plurality of predicted image data (e.g., shape data LD101′, LD105′, and LD106′) as a result of the input of the plurality of unprocessed image data (e.g., shape data LD001, LD005, and LD006) to the shape simulator 13. The predicted image data acquisition unit 902 notifies the acquired predicted image data to the closeness calculation unit 903.

The closeness calculation unit 903 calculates the closeness between each processed image data notified by the processed image data acquisition unit 901 (e.g., the shape data LD001′, LD005′, and LD006′) and each predicted image data notified by the predicted image data acquisition unit 902 (e.g., the shape data LD101′, LD105′, and LD106′). The closeness calculation unit 903 notifies the calculated closeness to the derivation unit 450. The closeness calculation unit 903 calculates the closenesses corresponding to the number of unprocessed image data input to the shape simulator 13, and notifies each calculated closeness to the derivation unit 450.

### (4) Specific Example of Process Performed by Derivation Unit

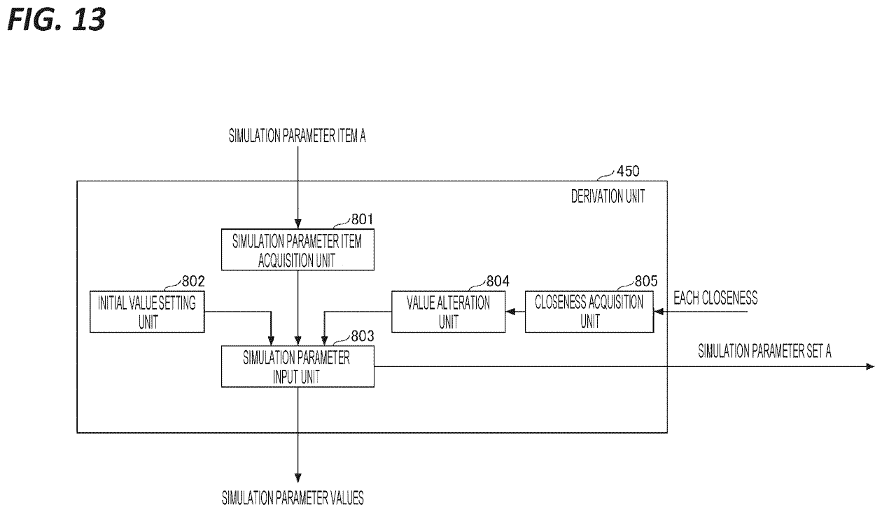

Next, a specific example of a process performed by the derivation unit 450 will be described. FIG. 13 is a view illustrating a specific example of the process performed by the derivation unit.

As illustrated in FIG. 13, the derivation unit 450 includes a simulation parameter item acquisition unit 801, an initial value setting unit 802, a simulation parameter input unit 803, a value alteration unit 804, and a closeness acquisition unit 805.

The simulation parameter item acquisition unit 801 acquires the simulation parameter items (e.g., the “simulation parameter items A”) from the aggregation unit 430, and sets the acquired simulation parameter items in the simulation parameter input unit 803.

The initial value setting unit 802 sets an initial value corresponding to each simulation parameter item, in the simulation parameter input unit 803.

The simulation parameter input unit 803 inputs the simulation parameter values when the plurality of unprocessed image data are input to the shape simulator 13. The simulation parameter input unit 803 inputs initial values at first, and thereafter, inputs values altered according to an instruction from the value alteration unit 804.

The simulation parameter input unit 803 outputs, to the output unit 460, the simulation parameter set (“simulation parameter set A” in the present embodiment) that consists of the optimal simulation parameter values, at which each closeness becomes equal to or more than the predetermined threshold value.

The value alteration unit 804 instructs the simulation parameter input unit 803 to alter the simulation parameter values. Specifically, when each closeness is notified from the closeness acquisition unit 805, the value alteration unit 804 makes an alteration instruction corresponding to the notified closeness, to the simulation parameter input unit 803. Further, the value alteration unit 804 makes alteration instructions corresponding to the number of simulation parameter items, to the simulation parameter input unit 803. The alteration instruction made by the value alteration unit 804 includes an alteration direction (increase or decrease) and an alteration amount.

As a result, the simulation parameter input unit 803 may input, to the shape simulator 13, the simulation parameter values corresponding to each closeness between the plurality of processed image data and the plurality of predicted image data.

The closeness acquisition unit 805 acquires each closeness notified by the calculation unit 440. The closeness acquisition unit 805 acquires each of the closenesses corresponding to the number of the unprocessed image data input to the shape simulator 13.

Further, the closeness acquisition unit 805 compares each acquired closeness with each previously acquired closeness, to determine whether each closeness has increased or decreased. The closeness acquisition unit 805 notifies each calculated closeness and the determination result thereof, to the value alteration unit 804. Then, the value alteration unit 804 may determine whether to make an alteration instruction (including the alteration direction and the alteration amount) for each of the simulation parameter values.

### Procedure for Parameter Deriving Method

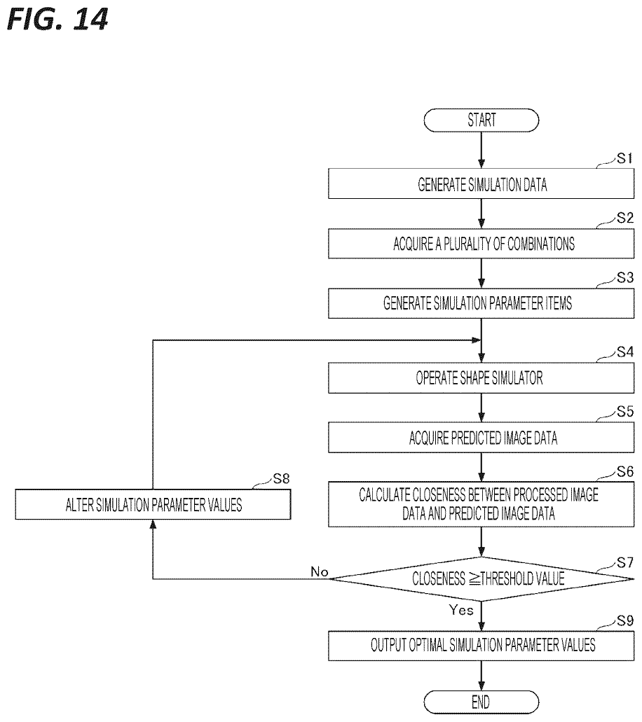

FIG. 14 is a flowchart illustrating an example of a parameter deriving method according to the present embodiment. The parameter deriving method according to the present embodiment is executed by the parameter derivation apparatus 12.

In step S1, the generation unit 410 reads out the collected data stored in the collected data storage unit 122. The generation unit 410 generates the simulation data based on the read-out collected data. The generation unit 410 stores the generated simulation data in the simulation data storage unit 123.

In step S2, the acquisition unit 420 reads out the plurality of unprocessed image data from the simulation data stored in the simulation data storage unit 123. The acquisition unit 420 inputs the read-out plurality of unprocessed image data to the shape simulator 13.

In step S3, the aggregation unit 430 generates the simulation parameter items to be input to the shape simulator 13. The aggregation unit 430 sends the generated simulation parameter items to the derivation unit 450.

In step S4, the derivation unit 450 receives the simulation parameter items from the aggregation unit 430. When step S4 is executed for the first time, the derivation unit 450 sets a predetermined initial value for each of the simulation parameter items, and inputs the simulation parameter items set with the initial values to the shape simulator 13. When step S4 is executed second or subsequent times, the derivation unit 450 inputs the simulation parameter values altered in step S8, to the shape simulator 13.

The shape simulator 13 operates using the plurality of unprocessed image data input from the acquisition unit 420 and the simulation parameter values input from the derivation unit 450, and outputs the plurality of predicted image data. The plurality of predicted image data output from the shape simulator 13 are sent to the calculation unit 440.

In step S5, the calculation unit 440 acquires the plurality of predicted image data output from the shape simulator 13. The calculation unit 440 reads out the plurality of processed image data corresponding to the plurality of predicted image data, from the simulation data stored in the simulation data storage unit 123.

In step S6, the calculation unit 440 calculates the closeness between each of the plurality of predicted image data and each of the plurality of processed image data that have been acquired. The calculation unit 440 sends each calculated closeness to the derivation unit 450.

In step S7, the derivation unit 450 receives the plurality of closenesses from the calculation unit 440. The derivation unit 450 determines whether each received closeness is equal to or more than the predetermined threshold value. When it is determined that each closeness is equal to or more than the threshold value (YES), the derivation unit 450 sends the simulation parameter values to the output unit 460, and proceeds with the process of step S9. Meanwhile, when it is determined that each closeness is less than the threshold value (NO), the derivation unit 450 proceeds with the process of step S8.

When all of the closenesses are equal to or more than the threshold value, the derivation unit 450 may determine that each closeness is equal to or more than the threshold value. Further, when the percentage of closenesses equal to or more than the threshold value is a predetermined value or more, the derivation unit 450 may determine that each closeness is equal to or more than the threshold value. When a statistical value of each closeness (e.g., an arithmetic mean or a median value) is equal to or more than the threshold value, the derivation unit 450 may determine that each closeness is equal to or more than the threshold value.

In step S8, the derivation unit 450 alters the simulation parameter values such that each closeness received from the calculation unit 440 increases. Then, the derivation unit 450 returns to the process of step S4. As a result, the processes of steps S4 to S7 are repeated until each closeness calculated by the calculation unit 440 becomes equal to or more than the predetermined threshold value.

In step S9, the output unit 460 receives the simulation parameter values from the derivation unit 450. The output unit 460 outputs the received simulation parameter values as the optimal simulation parameter values.

The simulation parameter values output from the output unit 460 are sent to, for example, the process condition optimization apparatus 14. As a result, the optimized simulation parameters are stored in the storage unit of the process condition optimization apparatus 14.

### Functional Configuration of Process Condition Optimization Apparatus

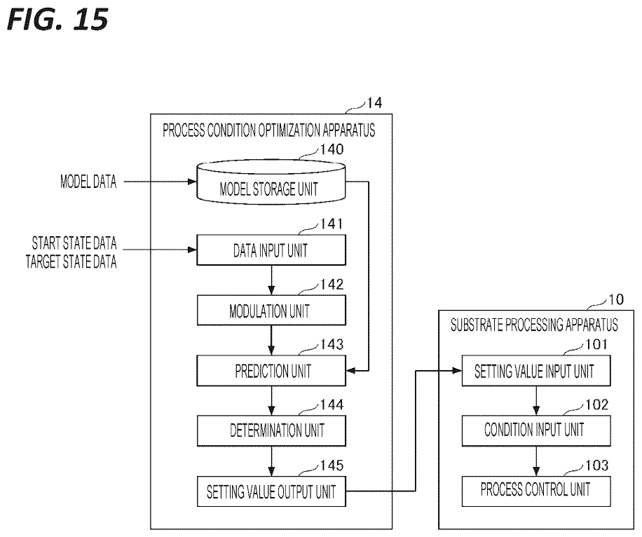

FIG. 15 is a block diagram illustrating an example of a functional configuration of the process condition optimization apparatus 14. As illustrated in FIG. 15, the process condition optimization apparatus 14 includes a model storage unit 140, a data input unit 141, a modulation unit 142, a prediction unit 143, a determination unit 144, and a setting value output unit 145.

The data input unit 141, the modulation unit 142, the prediction unit 143, the determination unit 144, and the setting value output unit 145 are implemented in the manner that, for example, the CPU 501 illustrated in FIG. 2 executes programs loaded on the RAM 503. The model storage unit 140 is implemented by, for example, by the RAM 503 or the HDD 504 illustrated in FIG. 2.

The model storage unit 140 stores model data constructed to reproduce the change of the workpiece as the effect of various processes. The model data includes recipe parameters for a process, and simulation parameters set based on the recipe parameters. The model data is generated for each process performed by the substrate processing apparatus 10.

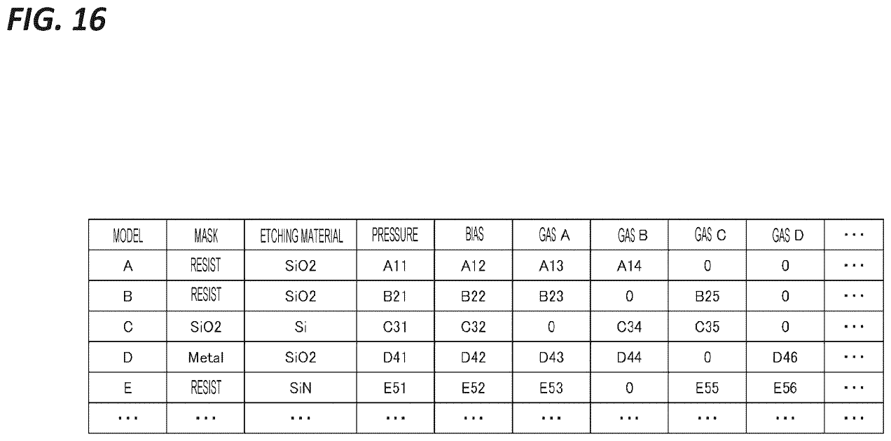

FIG. 16 is a view illustrating a specific example of the model data according to the present embodiment. As illustrated in FIG. 16, the model data is associated with identification information that identifies the model data for each process, recipe parameters for the corresponding process, and simulation parameters optimized for the corresponding process.

The simulation parameters are the simulation parameters of the shape simulator 13 derived by the parameter derivation apparatus 12. Accordingly, in the simulation parameters included in the model data, the simulation parameter values are set, which operate the shape simulator 13 to precisely reproduce experimental results.

The data input unit 141 receives input of the start state data and the target state data by the user. For example, the data input unit 141 receives input of the start state data and the target state data according to the operation by the user of the input device 505. For example, the data input unit 141 may receive the input of the start state data and the target state data by receiving the data from a user terminal such as a personal computer operated by the user.

The start state data includes three-dimensional structure information and material information of an unprocessed workpiece, which are modeled by, for example, shape modeling software. The start state data may include two-dimensional structure information and material information of an unprocessed workpiece. Further, the start state data may include one-dimensional structure information and material information, which may represent structure information and material information of an unprocessed workpiece.

When the process includes a dry etching process, the start state data includes, for example, structure information and material information of an etching mask and an etching film. When the process is a dry process, the dry process may be a film formation process such as a chemical vapor growth, a chemical vapor deposition, or a chemical deposition. When the process includes the film formation process, the start state data includes, for example, structure information and material information of an underlying layer and a film to be formed.

The target state data includes three-dimensional structure information and material information of a target processed workpiece, which are modeled by, for example, shape modeling software. The target state data may include two-dimensional structure information and material information of a target processed workpiece. Further, the target state data may include one-dimensional structure information and material information, which may represent structure information and material information of a target processed workpiece.

The modulation unit 142 modulates the start state data input to the data input unit 141, and generates one or more modulated data. The modulated data is obtained by modulating a portion of the structure or material of the workpiece in the start state data. The modulated data may include the start state data itself

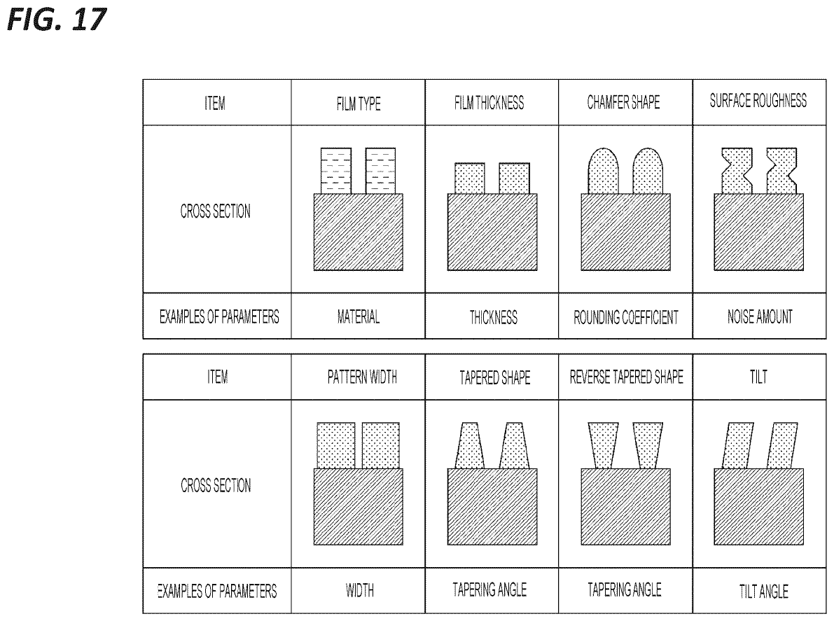

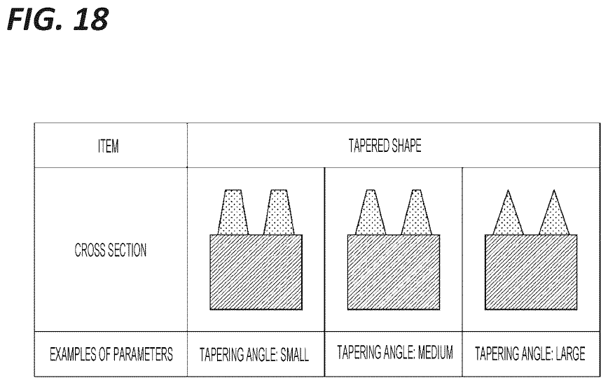

FIGS. 17 and 18 are each a conceptual view illustrating an example of the modulated data according to the present embodiment. As illustrated in FIG. 17, the modulated data is generated by modulating a predetermined item in an image representing the structure or material of the workpiece shown in the start state data (cross-sectional image and/or upper surface image). In the modulated data, for example, at least one item is modulated among, for example, a film type, a film thickness, a pattern width, a tilt shape, a chamfer shape, a tapered shape, and a surface roughness. In the modulated data, two or more items may be modulated among, for example, the film type, the film thickness, the pattern width, the tilt shape, the chamfer shape, the tapered shape, and the surface roughness.

Each of the items is set with parameters to be modulated. For example, when the film type is modulated, a layer number and materials before and after the modulation are set as parameters. Similarly, when the film thickness is modulated, a layer number and the thicknesses before and after the modulation are set as parameters. When the chamfer shape is modulated, a rounding coefficient after the modulation is set as a parameter. When the surface roughness is modulated, a noise amount (e.g., period and amplitude) after the modulation is set as a parameter. When the pattern width is modulated, the width after the modulation is set as a parameter. When the tapered shape or a reverse-tapered shape is modulated, a tapering angle after the modulation is set as a parameter. When the tilt shape is modulated, a tilt angle after the modulation is set as a parameter.

The modulation amount of each parameter may be determined from predetermined options, specified from a predetermined range, or randomly determined. For example, when the film thickness is modulated, the modulation amount may be selected from, for example, the options of 10 nm, 20 nm, and 30 nm, or may be determined in the range of 10 nm or more and 30 nm or less.

As illustrated in FIG. 18, the modulated data may include a plurality of modulated data, which is modulated by different parameters for one item. For example, when the closeness in tapered shape is estimated to be higher than the closeness in chamfer shape, the optimal solution is highly likely the tapered shape. In that case, it is preferable to generate a plurality of modulated data, which is different only in tapered shape with different tapering angles (e.g., large, medium, and small) (e.g., three modulated data with large, medium, and small tapering angles).

The modulation unit 142 may generate the modulated data when model data that meets a predetermined criterion may not be obtained for the start state data input to the data input unit 141. The predetermined criterion includes, for example, a criterion that the closeness between the end state data predicted by the prediction unit 143 and the target state data is equal to or more than the predetermined threshold value (e.g., 0.99).

The prediction unit 143 predicts the end state data of the workpiece by simulating the change of the modulated data generated by the modulation unit 42 through a process, using the model data or a combination of multiple model data stored in the model storage unit 140.

The determination unit 144 identifies the end state data and the modulated data, which are close to the target state data, from the end state data of the workpiece predicted by the prediction unit 143. When the identified modulated data is the start state data itself, the determination unit 144 selects, as the optimal solution, the model data or a combination of multiple model data that changes the input modulated data to the end state data with the highest closeness to the target state data. The determination unit 144 determines the recipe parameters included in the model data selected as the optimal solution, to be control setting values that will be output to the substrate processing apparatus 10. When the identified modulated data is not the start state data itself, the determination unit 144 notifies the user that the start state data needs to be modulated to obtain the optimal solution.

The setting value output unit 145 outputs the control setting values determined by the determination unit 144 to the substrate processing apparatus 10. The output by the setting value output unit 145 may include information indicating the optimal solution of the model data or the combination of multiple model data determined by the determination unit 144.

### Functional Configuration of Substrate Processing Apparatus

Referring back to FIG. 15, an example of the functional configuration of the substrate processing apparatus 10 according to the first embodiment will be described. As illustrated in FIG. 15, the substrate processing apparatus 10 includes a setting value input unit 101, a condition input unit 102, and a process control unit 103.

The setting value input unit 101 receives the input of the control setting values from the process condition optimization unit 14.

The condition input unit 102 inputs the control setting values input from the process condition optimization unit 14, as process conditions to the process control unit 103. Thus, the condition input unit 102 controls the operation of the process control unit 103.

The process control unit 103 executes a process based on the input control setting values.

### Procedure of Process Condition Optimization Method

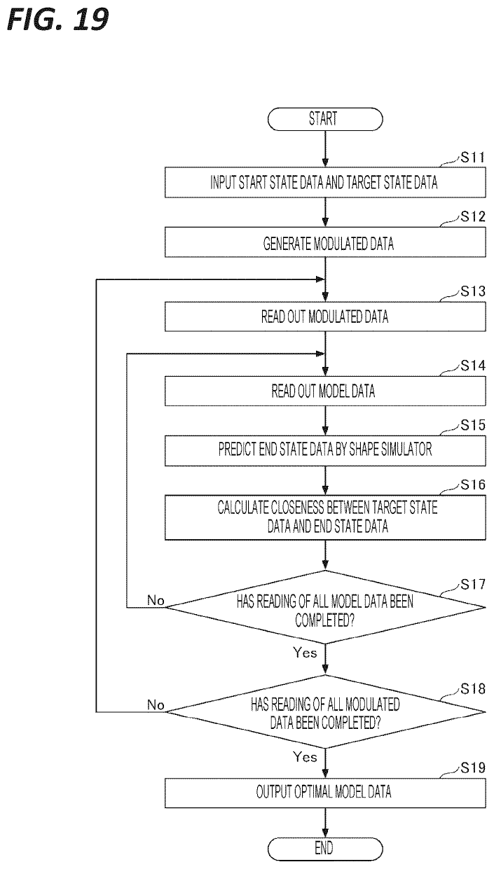

FIG. 19 is a flowchart illustrating an example of a process condition optimization method according to the present embodiment. The process condition optimization method of the present embodiment is executed by the process condition optimization apparatus 14.

In step S11, the data input unit 141 receives the input of the start state data and the target state data. Then, the data input unit 141 sends the start state data to the modulation unit 142. Further, the data input unit 141 sends the target state data to the determination unit 144.

In step S12, the modulation unit 142 receives the start state data from the data input unit 141. Then, the modulation unit 142 modulates one or more parameters of the start state data, and generates one or more modulated data. The modulated data may include the start state data itself. Then, the modulation unit 142 stores the generated one or more modulated data in the storage unit such as the HDD 504.

In step S13, the prediction unit 143 reads out one modulated data among the modulated data stored in the storage unit. The reading of the modulated data may be performed in a round-robin manner, may be performed randomly a set number of times, or may be performed until reaching an allowable closeness.

In step S14, the prediction unit 143 reads out the model data or a combination of multiple model data stored in the model storage unit 140. The reading of the model data or a combination of multiple model data to be used may be performed in a round-robin manner, may be performed randomly a set number of times, or may be performed until reaching an acceptable closeness.

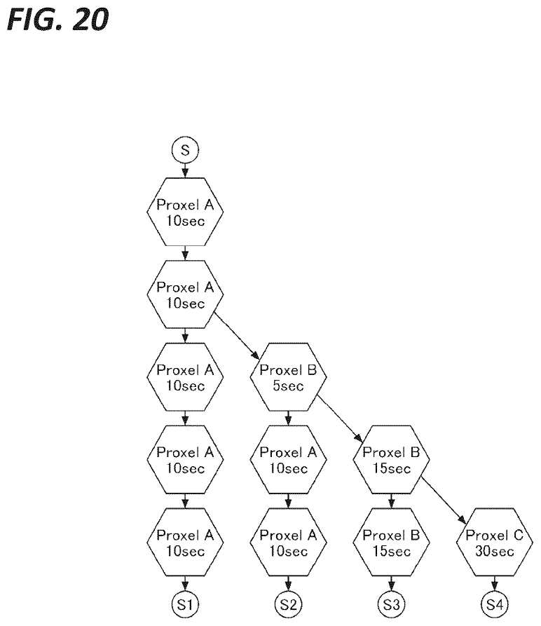

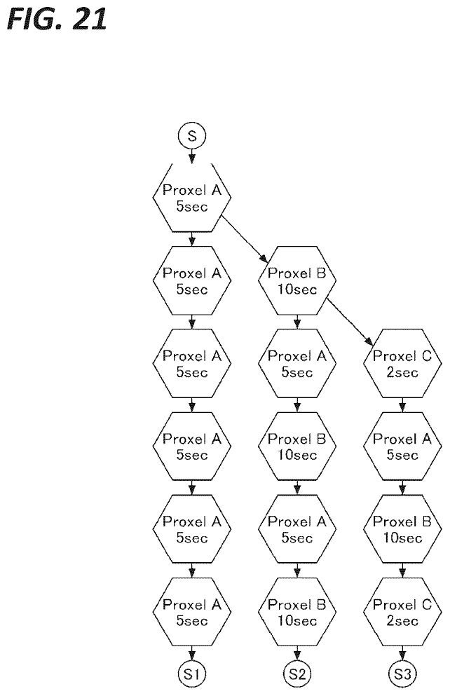

FIGS. 20 and 21 are each a conceptual diagram illustrating an example of a process of reading out a combination of multiple model data. In FIGS. 20 and 21, the model data is represented as “Proxel.” FIG. 20 is an example of a combination of five model data. FIG. 21 is an example of a combination of six model data. As illustrated in FIGS. 20 and 21, a combination of multiple model data may include multiple identical model data.

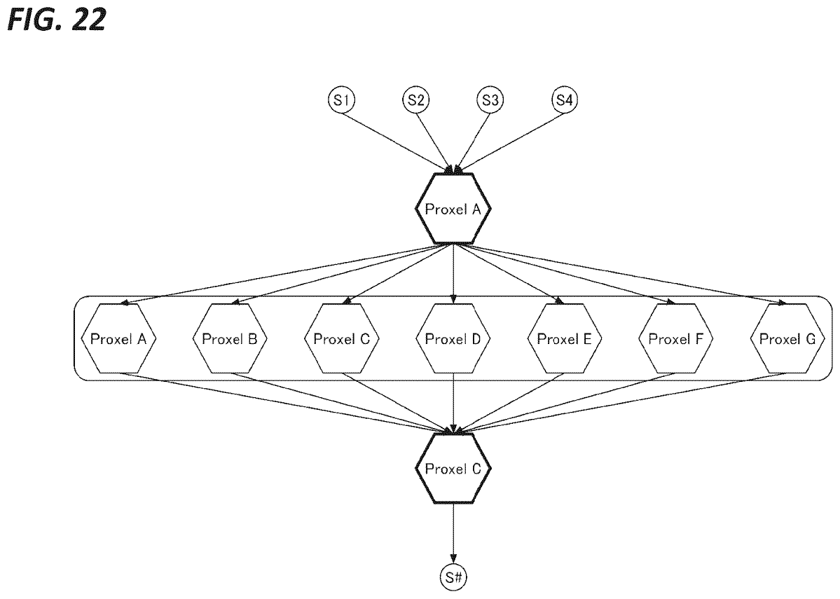

The process of reading out a combination of multiple model data may be performed as illustrated in FIG. 22. FIG. 22 is a conceptual diagram illustrating an example of the process of reading out a combination of multiple model data. FIG. 22 is an example of a combination of three model data, and represents an example where first model data “Proxel A” and third model data “Proxel C” are designated directly by the user. In the example of FIG. 22, different combinations of multiple model data may be read out by inserting or changing second model data.

Descriptions are continued referring back to FIG. 19. In step S15, the prediction unit 143 predicts the end state data of the workpiece by simulating the change of the workpiece shown in the modulated data read out in step S13 through a process, using the model data or a combination of multiple model data read out in step S14.

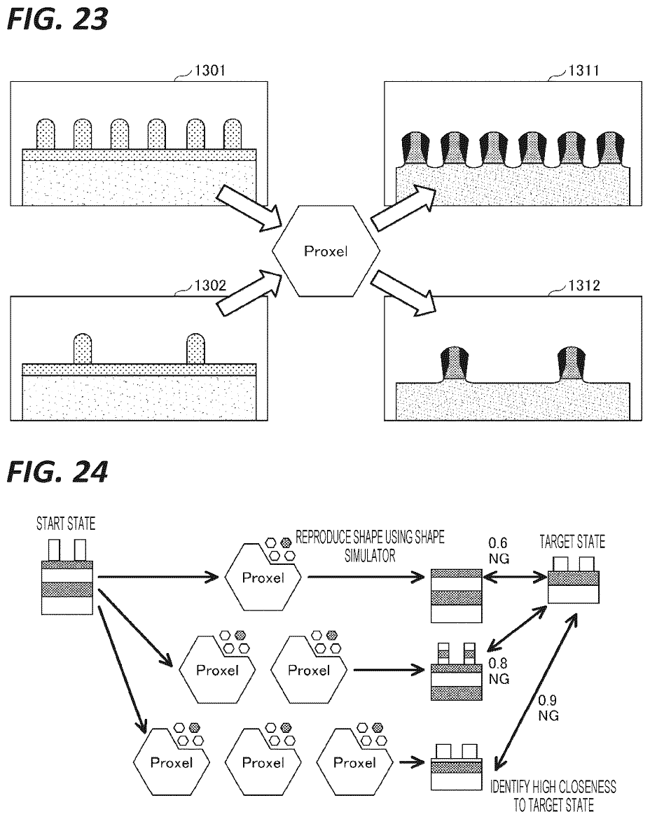

FIG. 23 is a conceptual view illustrating an example of the prediction process. For example, when one model data is read out in step S14, the end state data is predicted from the modulated data, using the one model data as illustrated in FIG. 23. Since the model data is associated with a predetermined process effect, end state data 1311 may be predicted in a case where modulated data 1301 is input. Similarly, end state data 1312 may be predicted in a case where modulated data 1302 is input. In this way, for example, when the modulated data have different shapes, the model data according to the present embodiment may predict different end state data for the modulated data.

When a combination of multiple model data is read out in step S14, the end state data is predicted from the start state data, using the multiple model data in an order from the front. In this case, the start state data of the first model data is the modulated data, and the start state data of the second or subsequent model data is the end state data of the previous model data. In this way, the prediction unit 143 predicts the end state data of the workpiece, using the model data or a combination of multiple model data read out from the model storage unit 140 in step S14.

Descriptions are continued referring back to FIG. 19. In step S16, the determination unit 144 calculates the closeness (or the degree of deviation) between the end state data of the workpiece predicted in step S15 and the target state data received in step S11.

In step S17, the determination unit 144 determines whether the reading of all of the model data or combinations of multiple model data has been completed. When it is determined that the reading has been completed (YES), the determination 144 proceeds with the process of step S18.

Meanwhile, when the reading has not been completed (NO), the determination unit 144 returns to the process of step S14. As a result, the processes of steps S14 to S17 are repeated until the closeness is calculated for certain modulated data, using all of the model data or combinations of multiple model data.

Meanwhile, when the reading of a combination of multiple model data is performed randomly a set number of times, the processes of steps S14 to S17 are repeated until reaching the set number of times. Further, when the reading is performed until reaching an allowable closeness, the processes of steps S14 to S17 are performed until the allowable closeness is calculated.

In step S18, the determination unit 144 determines whether all of the modulated data have been read out. When it is determined that all of the modulated data have been read out (YES), the determination unit 144 proceeds with the process of step S19.

Meanwhile, when it is determined that all of the modulated data have not been read (NO), the determination unit 144 returns to the process of step S13. As a result, the processes of steps S13 to S18 are repeated until the closeness is calculated for all of the modulated data using all of the model data or combinations of multiple model data.

In step S19, the setting value output unit 145 selects the model data or a combination of multiple model data with the highest closeness (or the smallest degree of deviation) calculated in step S16, as the optimal solution. The setting value output unit 145 may select, as the optimal solution, the model data or a combination of multiple model data with the highest closeness calculated in step S16 for the case where the modulated data is the start state data itself, and the model data or a combination of multiple model data with the highest closeness calculated in step S16 for the case where the modulated data is not the start state data itself The setting value output unit 145 outputs the selected optimal model data or combination of multiple model data to the substrate processing apparatus 10.

In the substrate processing apparatus 10, the setting value input unit 101 receives the input of the control setting values from the processing condition optimization apparatus 14. The condition input unit 102 inputs the control setting values received by the setting value input unit 101, as process conditions to the process control unit 103. The process control unit 103 executes a process based on the input control setting values.

In the process condition optimization method illustrated in FIG. 19, as the model data stored in the model storage unit 140 increases, the model data or a combination of multiple model data to be read in step S14 increases, and longer time is required until the optimal solution is selected. Thus, the process of reading out the model data or a combination of multiple model data in step S14 may be machine-learned using the closeness calculated in step S1 6 as an evaluation value, to improve the efficiency of the search for the optimal solution.

The search for the optimal solution may use the tree search, the graph search, the meta-heuristics, or a combination thereof. Further, the search for the optical solution may use a reinforcement learning to learn policies for selecting a process that produces the end state data close to the target state data.

For example, a method may be used, which searches for the optimal solution using genetic algorithms based on the closeness calculated in step S16. Further, for example, a method may be used, which performs the search using the degree of deviation from the target state data as a reward criterion (reinforcement learning), or a method may be used, which learns the relationship between the closeness to the target state data and the process conditions for a process, and performs the search using the degree of deviation from the target state data as a reward criterion (reinforcement learning).

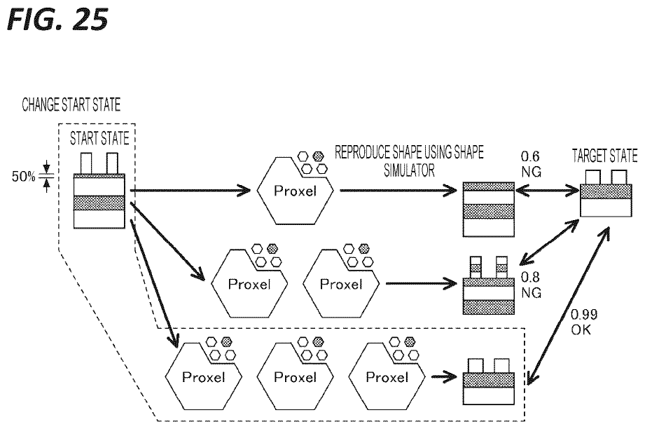

FIGS. 24 and 25 are each a conceptual view illustrating an example of the process performed by the process condition optimization apparatus 14. FIG. 24 illustrates a process of searching for model data (Proxel) that may obtain the end state data close to the target state data using the input start state data. Meanwhile, FIG. 25 illustrates a process of searching for model data (Proxel) that may obtain the end state data close to the target state data using modulated data, in which the shape of the input start state data (e.g., film thickness) is modulated.

### Effects of Embodiments

According to an embodiment of the present disclosure, the parameter derivation apparatus 12 generates the simulation data that includes a plurality of combinations of unprocessed data and processed data of the workpiece, and derives the simulation parameters of the shape simulator based on the closeness between predicted data predicted by inputting the unprocessed data included in the simulation data to the shape simulator, and the processed data combined with the unprocessed data. The combinations included in the simulation data include unprocessed data and processed data when a process is performed with a plurality of pattern densities for each of a plurality of mask shapes. According to the parameter derivation apparatus 12 of the present embodiment, it is possible to derive simulation parameters that may precisely predict the state of a workpiece after a process is performed on the workpiece.

In the parameter derivation apparatus 12 of the present embodiment, the processed data of the simulation data includes a plurality of processed data, in which a process is performed on a workpiece with different process times. According to the parameter derivation apparatus 12 of the present embodiment, it is possible to derive simulation parameters that may more precisely predict the state of a workpiece after a process is performed on the workpiece.

In the parameter derivation apparatus 12 of the present embodiment, the process may include an etching process on a substrate, and the unprocessed data may include structure information of an etching mask and an etching film. Further, in the parameter derivation apparatus 12 of the present embodiment, the mask shapes may include a line shape and a hole shape, and the pattern densities may represent the size of the spacing between lines or holes formed by the process. According to the parameter derivation apparatus 12 of the present embodiment, it is possible to derive simulation parameters that may precisely predict the state of a workpiece after an etching process is performed on the workpiece.

The processing condition optimization apparatus 14 of the present embodiment stores the simulation parameters of the shape simulator to reproduce the change of the workpiece when a process is performed on the workpiece under predetermined process conditions, generates the modulated data by modulating the input start state data of the workpiece, and determines process conditions for the process to be performed on the workpiece based on the closeness between the end state data predicted by inputting the modulated data and the simulation parameters to the shape simulator, and the input target state data. According to the process condition optimization apparatus 14 of the present embodiment, it is possible to precisely predict the state of the workpiece after a process is performed on the workpiece. As a result, it is possible to determine the process conditions that may precisely reproduce the target state of the workpiece.

In the process condition optimization apparatus 14 of the present embodiment, the process may include an etching process on a substrate, and the start state data may include structure information and material information of an etching mask and an etching film. In the process condition optimization apparatus 14 of the present embodiment, at least one of the film type, the film thickness, the pattern width, the tilt shape, the chamfer shape, the tapered shape, and the surface roughness may be modulated. According to the process condition optimization apparatus 14 of the present embodiment, it is possible to determine process conditions of an etching process that may precisely reproduce the target state of the workpiece.

The parameter derivation apparatus and the process condition optimization apparatus according the embodiments described herein are examples in all aspects, and should not be construed as limiting the present disclosure. The parameter derivation apparatus and the process condition optimization apparatus according to the embodiments are each an example of an information processing apparatus.

According to an aspect of the present disclosure, it is possible to precisely predict the state of a workpiece after a process is performed on the workpiece.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An information processing apparatus comprising:
a memory; and
a processor in communication with the memory and configured to:
generate simulation data including a plurality of combinations of unprocessed data of a workpiece and processed data of the workpiece after a process is performed on the workpiece under a predetermined process condition, the plurality of combinations each including the unprocessed data and the processed data when the process is performed with a plurality of pattern densities for each of a plurality of mask shapes; and
derive simulation parameters of a shape simulator based on a closeness between predicted data that is predicted by inputting the unprocessed data included in the simulation data to the shape simulator, and the processed data combined with the unprocessed data.

2. The information processing apparatus according to claim 1, wherein the processed data includes a plurality of processed data after the process is performed on the workpiece according to different process times.

3. The information processing apparatus according to claim 2, wherein the process includes an etching process on a substrate, and
the unprocessed data includes structure information of an etching mask and an etching film.

4. The information processing apparatus according to claim 2, wherein the process includes a film formation process on a substrate, and
the unprocessed data includes structure information of an underlying layer and a film to be formed.

5. The information processing apparatus according to claim 3, wherein the plurality of mask shapes include a line shape and a hole shape, and
each of the plurality of pattern densities represents a size of a spacing between lines or holes formed by the process.

6. The information processing apparatus according to claim 3, wherein the processor is configured to generate the plurality of processed data, in which an interval of process time is shortened near a boundary of the etching film.

7. An information processing apparatus comprising:
a memory; and
a processor in communication with the memory and configured to:
store simulation parameters of a shape simulator to reproduce a change of a workpiece when a process is performed on the workpiece under a predetermined process condition;
receive an input of start state data and target state data of the workpiece;
generate modulated data by modulating the start state data;
input the modulated data and the simulation parameters to the shape simulator, thereby predicting end state data of the workpiece after the process is performed on the workpiece under the process condition; and
determine the process condition of the process to be performed on the workpiece, based on a closeness between the end state data and the target state data.

8. The information processing apparatus according to claim 7, wherein the process includes an etching process on a substrate, and
the start state data includes structure information of an etching mask and an etching film.

9. The information processing apparatus according to claim 8, wherein the start state data further includes material information of the etching film.

10. The information processing apparatus according to claim 7, wherein the process includes a film formation process on a substrate, and
the start state data includes structure information of an underlying layer and a film to be formed.

11. The information processing apparatus according to claim 9, wherein the processor is configured to modulate at least one of a film type, a film thickness, a pattern width, a tilt shape, a chamfer shape, a tapered shape, and a surface roughness.

12. An information processing method comprising:
generating simulation data including a plurality of combinations of unprocessed data of a workpiece and processed data of the workpiece after a process is performed on the workpiece under a predetermined process condition, the plurality of combinations each including the unprocessed data and the processed data when the process is performed with a plurality of pattern densities for each of a plurality of mask shapes; and
deriving simulation parameters of a shape simulator based on a closeness between predicted data that is predicted by inputting the unprocessed data included in the simulation data to the shape simulator, and the processed data combined with the unprocessed data.
